(19) United States
(12) Patent Application Publication
(10) Pub. No.: US 2007/0084305 A1
(43) Pub. Date: Apr. 19, 2007

(54) Pedal-wound step-conveying devices

(76) Inventor: Anadish Kumar Pal, Delhi (IN)

Correspondence Address: ANADISH KUMAR PAL, 194 VAISHALI, PITAMPURA, DELHI, 110088, IN

(21) Appl. No.: 11/315,015

(22) Filed: Dec. 23, 2005

(30) Foreign Application Priority Data
Oct. 18, 2005 (IN) 2781/DEL/2005

(51) Int. Cl. G05G 1/14

(52) U.S. Cl. 74/512

(57) ABSTRACT

Pedal-wound step-conveying devices employing lever- or diaphragm-type pedal-pressure-receiving mechanisms and epicyclic-gear-train or hydraulic transformers to produce a torque to wind a reinforced elastomeric strip, or a number of generally parallel strips, backwards to produce a forward motion in a pedal-pressure-applying appendage engaged in bipedal or quadruped locomotion. Next, the lifting of the device along with the appendage in bipedal or quadruped locomotion allows the spring-driven unwinding of the strip or strips to ready for the next pedal-pressure application by the appendage to produce another forward motion in the appendage, and so on. Small motors-cum-electric generators mechanically linked to the torque produced by the epicyclic-gear-train or hydraulic transformers augment the torque or convert an undesired torque into electricity for auxiliary purposes, accordingly. A number of reinforced elastomeric strips, respectively winding and unwinding together, are guided by tandem-placed pulleys to generally follow the sideways profile of a pedal-wound step-conveying device.

### CROSS-REFERENCE TO RELATED APPLICATIONS

Foreign application priority claimed from Indian Patent Application No. 2781/DEL/2005 of Oct. 18, 2005, entitled, ‘Pedal-wound step-conveying devices.’

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

This invention relates to improvement in pedal locomotion by providing devices aimed at utilizing the kinetic energy of normal pedal locomotion for producing a finite translatory motion. All the present-day devices are mostly incomplete and are quite heavy. They also have either no deceleration mechanisms, or have distally located deceleration controls which are cumbersome. There also is a complete absence of any method to foolproof the possibility of a forward roll off with a gathering of momentum with the initial stepping. Chinese patents CN1094649 and CN1101588 respectively utilize chain-operated and pneumatic mechanisms to drive wheels for aiding bipedal locomotion. The basic weakness of an accidental forward roll off remains due to the use of a vane-type motor to drive the wheel or wheels. Due to internal leakage at slow speeds, a vane-type motor can keep rotating as a pump under the influence of an external torque, even when the supply port is closed. The use of a pneumatic mechanism makes the concerned invention susceptible to atmospheric vagaries. An accidental entry of dust and moisture may hasten the deterioration of the pneumatic vane-type motor. Further, even in a mechanical gear- or chain-based device, the torque generated on the slowest-speed shaft could be great enough to damage the gear teeth, and might also lock the gears or the driving levers of the pedals during the accidental forward roll off. U.S. Pat. Nos. 5,280,935 and 6,626,442 are with geared mechanical drives and offer no solution to the problem of accidental forward roll off, as they are skating devices, not intended to be completely lifted off ground. Powered roller skates and track shoes with belts and wheels with driving mechanisms are not suitable for a normal bipedal locomotion action resulting in human walking, this is mainly due to the extra weight they tend to add to the weight of the shoes. Although, it is a great advantage for the wearer of such a device to be able to walk normally by lifting the device with the foot, to be able to step normally and safely by placing the foot on an obstacle-free place on the ground. In spite of the limitation just discussed, French patent FR2811585 discloses a hydraulic mechanism of interest. But the inclusion of a check valve (22 in FIG. 2 of the patent disclosure) adds to the free-rolling characteristics of the invented roller skates and makes it equally unsuitable to normal bipedal locomotion. It has also been noted with great concern recently that an increase in the speed of locomotion in human upright posture is unsuitable with regards to the safety to the human body. Pavements and sidewalks are not designed for a speedy human rolling movement. A human body at higher than normal speeds finds it difficult to respond to obstacles by lifting one foot at a time. Only a conscious effort imparted by training can make one achieve this skill. Furthermore, the use of small wheels though makes a skate lightweight, but it also makes it noisy and uncomfortable to ride. On the contrary, large skate wheels make a skate easy to roll but very heavy to lift with normal leg movement associated with human bipedal locomotion. The use of endless tracks or belts with pulleys or rollers, solves the problem of a noisy and rough ride; but dirty road condition can easily get in the gap between the upper and lower section of the belt riding the pulleys or the rollers and jam the movement of the belt to quite some degree, leading to the failure of the forward-rolling mechanism. This situation is aggravated, as the dirt tends to stick to the endless track or the belt and gets thrown on the sole of the shoe, which forms the ceiling of the belted mechanism. Another major problem with this kind of skating or stepping device is the minimum tension requirement, if the endless track is an elastomeric belt; and if the endless track is a caterpillar-like mechanism, dirt gets into the linkages of the track and tends to foul the mechanism. The consequence of which is increased friction and a low mechanical efficiency. An average human being is known to produce nearly a quarter of a horsepower during sustained cycling experiments—leisurely walk produces lesser power. An approximate estimate by theoretical calculations for a 70 kg human is 70 watts. Evidently lowered efficiency in bipedal locomotion conveying devices would make them ineffective, as nearly 50 watts is required to move a 70 kg human resting on a rolling mechanism, at a speed of 5 km per hour.

### BRIEF SUMMARY OF THE INVENTION

Consequent to the present level of prior art discussed hereinabove, there is a need for a device which can solve the following problems and can offer an affordable and disposable artifact to enhance human bipedal locomotion: (1) accidental free roll off with initial stepping, when the whole human body has not gathered sufficient forward momentum; (2) accidental damage to the driving mechanism due to the momentum of the traveling human body; (3) decreasing the weight of the drive mechanism to make it suitable for the lifting action of legs while walking; (4) reducing the treading height to complement the feeling of a normal walk; and (5) to increase road contact without increasing either the number of wheels or the diameter of the wheels. The present invention solves the issues discussed hereinabove uniquely by using a thin non-looped conveyor alternatively winding and unwinding in an oscillatory manner on two rotating spools dynamically secured respectively on the two extremities of the fore-and-aft axis of the bipedal appendage. A left-right alternation of the bipedal center of gravity and the consequent production of kinetic energy which has its source in chemical energy, is utilized to either produce a hydraulic pressure gradient or a torque in the mechanisms of one embodiment of the present invention. A flat-pack enclosure is placed beneath the bottom sides of the bipedal appendages. The flat-pack enclosures have a certain amount of flexibility to distort under the bipedal force alternation at the time of normal bipedal locomotion. The flat-pack enclosures are filled fully with an appropriate hydraulic fluid which alternately flows out under pressure with the bipedal force alternation, to cause movement in a ball-screw-type rotary actuator, the rotations in which are coupled by a number of fixed-axis planet pinions to two rotating large internally geared small spools which cylindrically encase the ball-screw-type rotary actuators and wind two similar and limited lengths of thin reinforced elastomeric conveyors alternately. This hydraulic power action takes place while one of the hydraulic mechanisms of the present invention being described herein bears the bipedal mass variably. This forced winding of the conveyor results in the translatory motion of the involved bipedal appendage bearing the bipedal mass variably. After that, when the bipedal mass is shifted on to the other bipedal appendage, the bipedal appendage undergoing the translatory motion just described is lifted and the front-placed spool with a spring type energy reservoir, starts rotating to unwind the rear-placed spool whose winding action is just described, to wind the elastomeric conveyor on itself. This second winding action takes place when the bipedal appendage is lifted. The action described hereinabove keeps taking place with successive alternation to add translatory motion to hitherto stationary nature of steps in the normal action of bipedal locomotion. A hydraulic flow constrictor is used to restrict the hydraulic fluid flow to the rotary actuator to disable the translatory-motion-providing function of the present embodiment of the invention. In the second embodiment of the present invention, the hydraulics is replaced with torque transforming rotatory planetary compound mechanisms. Multiple planetary gear trains are used in series to amplify the angular movement produced by a nutcracker-like arrangement, the pivot of which is common to the axis of the planetary gear trains. The amplified angular movement is transferred to the conveyor-winding spool by using the arrangement described in the first embodiment of the present invention, namely, a number of fixed-axis planet pinions. The nutcracker-like arrangement converts the bipedal force alternation at the time of normal bipedal locomotion described hereinabove into a small angular movement. The spools on the front end of the bipedal appendages have two identical locking mechanisms to stop the spring-loaded spools from getting unwound; this inhibits the functioning of this embodiment of the present invention as and when required.

Additionally, a small alternator can also be placed inside any of the spools to partially convert the kinetic energy into electricity for auxiliary use. To further ergonomic enhancement to all the embodiments of the present invention, the thin conveyor as described in the preceding summary, is widthwise split in narrow strips of dissimilar lengths. The inward-facing surfaces of all such strips have lengthwise roller-following ridges to keep riding their respectively allotted small rollers. The two spools are also similarly lengthwise stepped to resemble an hourglass-like figure formed as if by circularly joining stacked rings of different diameters.

Further usefulness of all the embodiments of the present invention is for the handicapped and the infirm. Without any danger of a fall, they can walk with ease with the use of the embodiments of the present invention explained hereinabove. An interesting and useful application of the present invention is for speeding up quadruped mobility by utilizing the first embodiment of the present invention for the quadrupeds, especially for the animals of burden. Cart-pulling quadrupeds can attain higher speeds by using the devices of the present invention. These devices complement the age-old horseshoe.

The present invention in various embodiments endeavors to solve the problems present in prior art in following stepwise manner: (1) accidental free roll off with initial stepping, when the whole human body has not gathered sufficient forward momentum is fully contained by making use of a limited length of a track which as a conveyor transports the bipedal appendage resting on it, and rewinds back to start a new conveyor action as soon as the resting bipedal appendage or foot lifts the limited length of the track with all the mechanisms off ground; (2) accidental damage to the driving mechanism due to the momentum of the traveling human body is prevented again by employing the limiting length of the track to function as a conveyor, as soon as the limited length of the track is fully wound and the foot resting on its mechanism is carried forward to the fullest extent, the end of the track stops further winding of the spool and thus limits catastrophic torque generation at the pedaling end of the gear train inside the winding spool; (3) decreasing the weight of the drive mechanism to make it suitable for the lifting action of legs while walking is achieved by reducing the diameter of the rollers, making the conveyor belt thin and integrating the driving and conveying mechanism to the fullest with the footwear, this aim is also achieved by doing away with the top-side roll of the endless track over the rollers or pulleys; (4) reducing the treading height to complement the feeling of a normal walk is done again by doing away with the top-side travel of the endless track over the rollers or pulleys in the present invention; and (5) to increase road contact without increasing either the number of wheels, or the diameter of the wheels, or the friction in the movement of the conveying mechanism, the inward-facing surface of the limited length of the track or the conveyor is non-elastomeric, as no frictional gripping is required from this inward-facing surface; this approach reduces friction between the small rollers and the conveyor. The adhesion of dirt also cannot stick well to the smooth surfaces provided by the small rollers and the inward-facing surface of the conveyor. Additionally, the small rollers are multi-line and with non-coincidental axes of rotation make the external road-contacting surface of the conveyor resemble a section of a large-diameter wheel, thus, increasing the smoothness of bipedal locomotion with the help of the conveyor means of the present invention.

In one embodiment of the present invention a hydraulically operated oscillating bipedal step-conveying device is integrated as a vehicular arrangement with a footwear device.

In another form of the present invention, a gear-based, mechanically operated oscillating bipedal step conveying device is integrated as a vehicular arrangement with a footwear device.

In yet another form of the present invention, a gear-based, mechanically operated oscillating bipedal step conveying device is implemented as a vehicular attachment to a footwear device.

In a further form of the present invention, a hydraulically operated oscillating bipedal step conveying device with auxiliary electric-generation and electric-drive ability is integrated as a vehicular arrangement with a footwear device.

In still another form of the present invention, a gear-based, mechanically operated oscillating bipedal step conveying device with auxiliary electric-generation and electric-drive ability is integrated as a vehicular arrangement with a footwear device.

In an additional form of the present invention, a gear-based, mechanically operated oscillating bipedal step conveying device with auxiliary electric-generation and electric-drive ability is implemented as a vehicular attachment to a footwear device.

A further common feature of the present invention is a plan and method to route multiple conveyors of dissimilar lengths to follow the curved perimeters of a sole-profiled bottom of all the embodiments of the present invention.

In an even further embodiment of the present invention, a hydraulically operated oscillating quadruped step conveying device is integrated as an arrangement with an animal footwear device or a horseshoe.

To assist in the understanding of the present invention recourse is taken to making use of drawings depicting the various functional and constructional aspects of the present invention in conjunction with the section of detailed description of the preferred embodiment.

### BRIEF DESCRIPTION OF THE SEVERAL VIEWS OF THE DRAWINGS

Accompanying drawings on 7 sheets are 11 in number. Except for in schematic representations for an overview, as in FIG. 1, FIG. 5, FIG. 9, FIG. 10 and FIG. 11, all the drawings are stipple shaded to reflect various forms of the different embodiments of the present invention.

FIG. 1 shows schematically mixed sectional side view of the hydraulically operated embodiment of the present invention.

FIG. 2 shows a bottom view of the hydraulically operated embodiment of the present invention, with a major portion of the conveyor torn away to facilitate the view of the arrangement of the small rollers.

FIG. 3 is a partial cut-away view taken along line 21-21 in FIG. 2 showing the partial location of small rollers.

FIG. 4 is a partial cut-away view taken along line 20-20 in FIG. 1, where the stretched-out conveyor is broken away from near the ends.

FIG. 5 shows a mostly schematically mixed, cut-away side view of the mechanically operated gear-train embodiment of the present invention.

FIG. 6 shows a bottom view of the mechanically operated gear-train embodiment of the present invention, with a major portion of the conveyor torn away to facilitate viewing of the arrangement of the small rollers.

FIG. 7 is a partial cut-away view taken along line 23-23 in FIG. 6 showing the partial location of small rollers.

FIG. 8 is a partial cut-away view taken along line 22-22 in FIG. 5, where the stretched out conveyor is broken away from near the ends.

FIG. 9 is a schematic bottom view of the multiple-routed conveyor placement plan of the present invention, commonly possible to all the embodiments of the present invention.

FIG. 10 is a partial diagrammatic sectional view following the pattern of FIG. 3 and FIG. 8, to show the fore-and-aft axis orientation of small rollers to the multiple routed conveyors in the placement plan shown in FIG. 9.

FIG. 11 is the general hydraulic circuit for the hydraulically operated embodiment of the present invention.

### DETAILED DESCRIPTION OF THE INVENTION

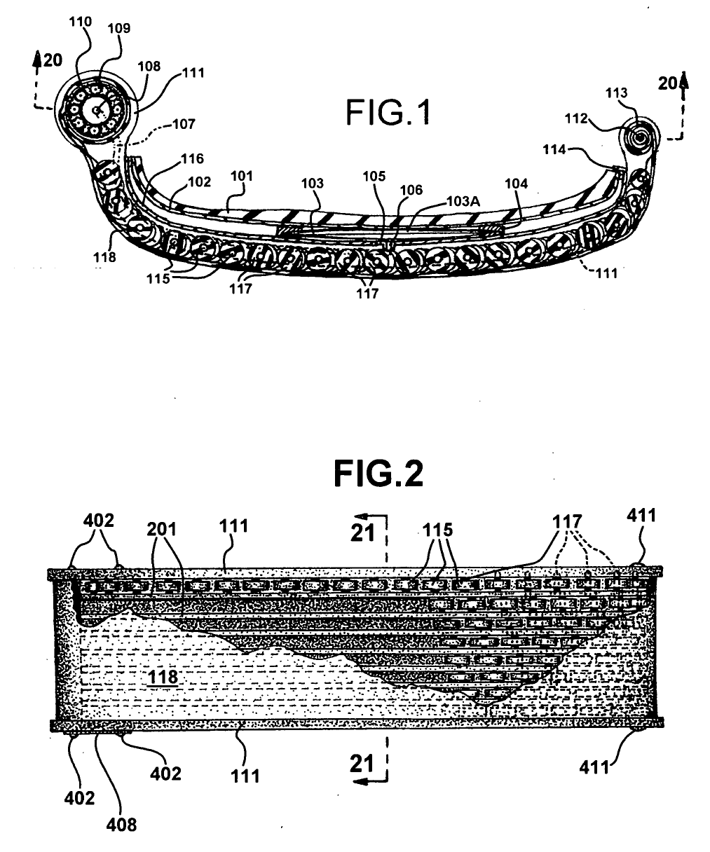

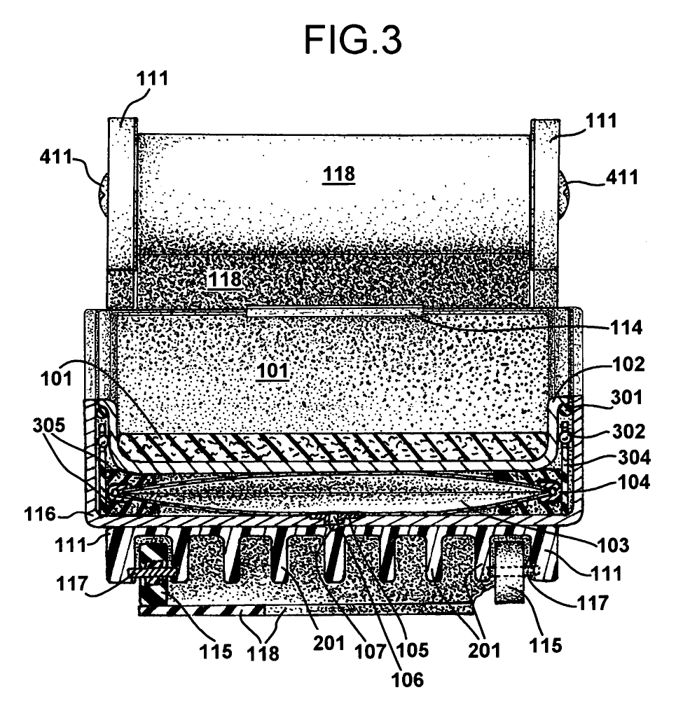

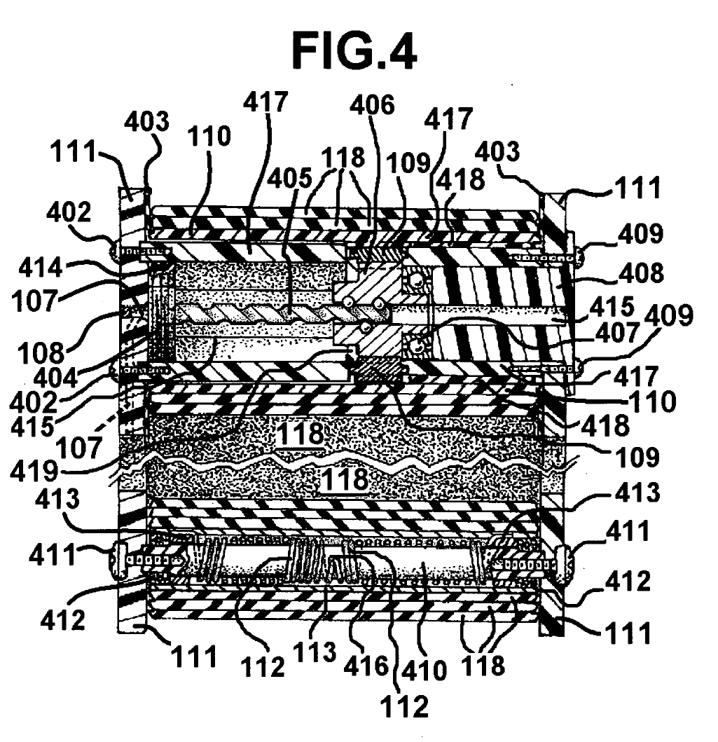

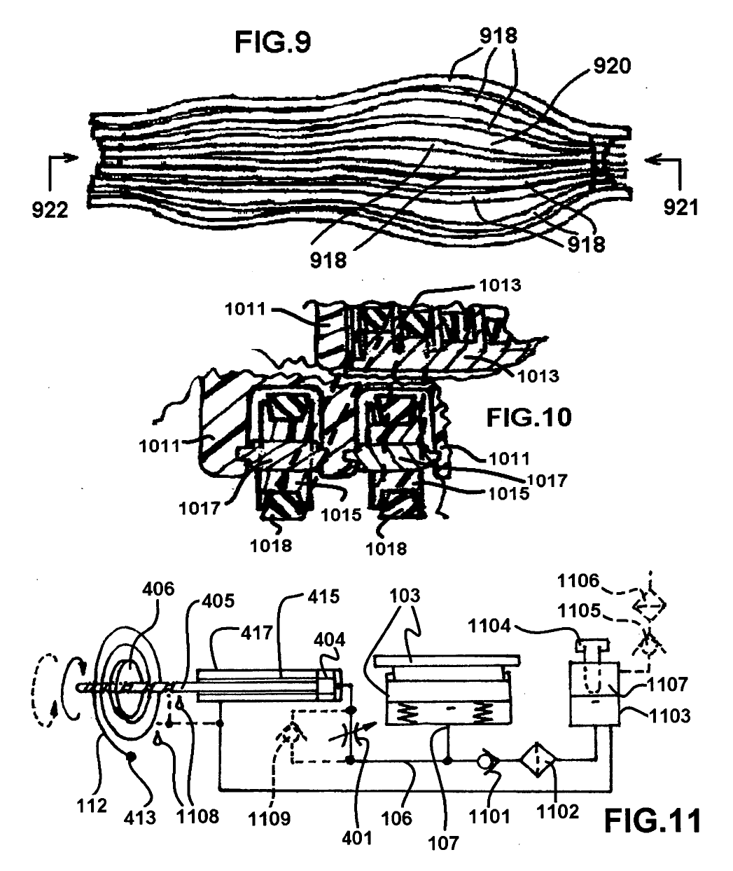

One of the embodiments of the present invention is illustrated in FIG. 1 through FIG. 4 and in FIG. 11. In FIG. 1 through FIG. 4, cradle base 111 is a tough thermoplastic structure to hold spool 110 and second spool 113 (FIG. 1 and FIG. 4) with the rest of the components. Cradle base 111 has mostly equidistance parallel ridges 201 (FIG. 2, FIG. 3 and FIG. 4) to rotatably hold rollers 117 (FIG. 1, FIG. 2 and FIG. 3) by their spindles 115 (FIG. 1, FIG. 2 and FIG. 3). Sole base 101 (FIG. 1 and FIG. 3) is of elastomeric composition. Sole base 101 provides a resilient base to the appendage, in this case, the foot engaged in bipedal (or quadruped, in other embodiments of the present invention) locomotion. Sole base plate 102 (FIG. 1 and FIG. 3) acts along with sole bottom plate 116 (FIG. 1 and FIG. 3) as the upper and lower platens of a regular hydraulic press working in reverse. Flat-pack cavity 103 (FIG. 1, FIG. 3 and FIG. 11) has a tubular outlet 107 (FIG. 1, FIG. 3, FIG. 4 and FIG. 11) through opening 106 (FIG. 1, FIG. 3 and FIG. 11) in flanged nipple 105 (FIG. 1 and FIG. 3). Buffer 305 (FIG. 3), made of sponge rubber, helps locate flange ring 104 (FIG. 1 and FIG. 3) between sole base plate 102 and sole bottom plate 116. To reduce the entry of external contaminants into the empty space formed between sole base plate 102 and sole bottom plate 116, loose O-ring 301 (FIG. 3) is provided underneath a small flange created at the top edge of sole base plate 102, in the gap between the internal faces of the vertical walls of sole base plate 102 and sole bottom plate 116. Just below loose O-ring a bearing strip 304 preferably made of a thermoplastic has holes at regular intervals to position small slide balls 302 (FIG. 3). Small slide balls 302 form a sliding bearing together with bearing strip 304 to maintain a uniform sliding clearance between sole base plate 102 and sole bottom plate 116. Hinge-forming bend 114 (FIG. 1 and FIG. 3) limits the upward movement of base plate 102 to form a pivotal line for the compression (taking place around region 103A in FIG. 3) of the hydraulic fluid inside flat-pack cavity 103 to flow under pressure through opening 106 (FIG. 3), tubular outlet 107 into the cavity of the single-rod, single-acting, spring-return hydraulic cylinder made up of cylinder body 417 (FIG. 11), back-side end plate 111, piston-rod end plate 419, piston 404 (FIG. 11), piston ring 414 and piston rod 405 (FIG. 11) (all shown with physical clarity in FIG. 4), regulated by a manually operated throttle valve 1110 (FIG. 11) (with a parallel check valve 1109 in FIG. 11) located at the point shown by a simple stopper 108 (FIG. 4). Cylinder body 417 is secured to backside end plate 111 with the help of screws 402 (FIG. 2 and FIG. 4). Piston rod 405 is formed into a helical-screw or ball-screw rotary actuator by mating axially and helically with a correspondingly grooved and possibly ball-loaded rotor driver sun gear wheel 406 (FIG. 4 and FIG. 11) rotatably fixed with actuator main bearing 407 (FIG. 4). Actuator main bearing 407 is secured using end-plate head 408 (FIG. 4). End-plate head 408 has a hollow shaft 415 (FIG. 4) for the linear movement of piston rod 405. End-plate head 408 (FIG. 4) is secured to the second end plate 111 on the piston-rod side with screws 409 (FIG. 4). End-plate head 408 can be modified to accommodate a small dc or brush-less dc BLDC motor to augment the torque generated by the hydraulic system. Conversely, the motor can function as an electric generator when less step conveying is desirable. A small electronic circuitry with semiconductor switches routes the electric power accordingly. Like the manually or pilot-controlled throttle valve discussed hereinbefore, an electronic control in the form of an analogue potentiometer or a digital up-down control with switches is provided on the embodiment of the present invention to externally control the functioning of the motor either as a charger or a torque-augmenting device. A small rechargeable lightweight battery (Li-ion or Ni MH) or an electrolytic capacitor can be used, according to the duration of the augmentation desired in the device of the present invention. Sun gear wheel 406 rotationally drives a number of angularly equidistance small planet gear wheels 109 (FIG. 1 and FIG. 4) rotatably fixed on appropriate slots in corresponding places in cylinder body 417 which also acts as the fixed satellite carrier in this case. Planet gear wheels 109 together in turn rotationally drive annulus gear wheel follower integrated to spool 110 (FIG. 1 and FIG. 4). The rotation of spool 110 winds one strip 118 (FIG. 1, FIG. 2, FIG. 3, FIG. 4 and FIG. 9) or a number of strips 1018 (FIG. 10) to make strip 118 or strips 1018 move backwards to the direction of bipedal or quadruped locomotion, which in turn conveys the foot forward. Two thin rubber washers 403 (FIG. 4) act as anti-dust gaskets to prevent the entry of dust in the bearing formed between cylinder body 417 and the inner surface of spool 110. As the leg folds at the knee and the foot is lifted off ground, the device being explained currently also gets off ground; and a spring-return mechanism unwinds strip 118 or a number of strips 1018 (FIG. 10) off spool 110 to coil around second spool 113 (FIG. 4) and in the process effects the spring-return action of the hydraulic cylinder described here; this mechanism consists of two helically wound springs 112 (FIG. 4 and FIG. 11) placed around end-plate-locating shaft 410 (FIG. 4) with the medial ends linked to end plate locating shaft 410 and either stuck into hole 416 (FIG. 4) or onto a pin fixed into hole 416, the distal ends of springs 112 linked to second spool 113 (FIG. 4) with the use of holder rings 413 (FIG. 4 and FIG. 11) and second spool rotatably secured with the use of two ball bearings 412 (FIG. 4). End plate locating shaft 412 is secured to two end plates 111, using two screws 411 (FIG. 2, FIG. 3 and FIG. 4).

The hydraulic cylinder described in the preceding paragraph has to have the feature of piston 404 from rotating inside cylinder body 417 (FIG. 4 and FIG. 11). Normally, a guide rod with a rubber seal can be used. But in FIG. 4, in order to reduce internal leakage, a hexagonal or elliptical internal cross-section profile for the inside of cylinder body 417 (FIG. 4 and FIG. 11) is more appropriate. Axial hexagonal line 415 (FIG. 4 and FIG. 11) is convenient to build in a hydraulic-cylinder design, but an elliptical internal cross section would provide a better sealing properties. Hydraulic fluid tank 1103 with strainer cum cap 1104, air space 1107 and optional air filter 1106 and air check valve 1105 are shown in FIG. 11. These components are only to be used if the embodiment of the present invention has to be made extremely reliable and efficient. The use of a high-viscosity hydraulic fluid can minimize leakages, however, it will lower the mechanical conversion efficiency somewhat. Hydraulic fluid leakage 1108 (FIG. 11) can be put to use to lubricate piston rod 405 and sun gear wheel 406. Check valve 1109 is used optionally to enable the spring return of piston 404 for the start of a fresh winding cycle after manually operated throttle valve 1110 (FIG. 11) is closed in order to disable the embodiment of the present invention being discussed. Hydraulic fluid tank 1103 with its associated components can be built with end-plate head 408 (FIG. 4) by modifying the construction of end-plate head 408. Hydraulic return lines shown in FIG. 11 can be had in cylinder head 111 which is clamped to end-plate head 408; for this purpose, tubular outlet 107 has to cross 201 fully. Another way is to have a hollow link shaft joining the two cylinder heads 111 at the extreme rear end of the device being discussed and using this hollow link shaft as hydraulic fluid tank 1193. It has to be borne in mind that helical-screw-type rotary hydraulic actuators are not very efficient if made ordinarily. A precision manufacture with ball-loaded screw improves the performance. Hollow shaft 415 can also have a weak compression-type spring to aid in the spring return of the hydraulic cylinder. The inclusion of this spring helps in making helically wound springs 112 softer and hence it can be made with a smaller diameter spring wire than described earlier. It can also be stated that the use of a vane-type hydraulic motor would need a typical hydraulic return circuit and check valves with a hydraulic tank. The manufacture of a miniature lightweight hydraulic motor is only possible when large-scale production is intended. However, an efficient miniature hydraulic motor can easily replace the rotary actuator as described hereinabove. The length or lengths of winding strip 118 or strips 1018 determine the revolutions of the hydraulic-motor shaft. The spring-return action of flat-pack cavity 103 also becomes more important, as there would be leakage in the return action of the hydraulic motor acting as a pump even if there is no check valve in the hydraulic return line, and the volume of hydraulic fluid pumped back with the unwinding action of spool 110 would always be slightly less than the hydraulic fluid pushed into the hydraulic motor by the pedal pressure on flat-pack cavity 103.

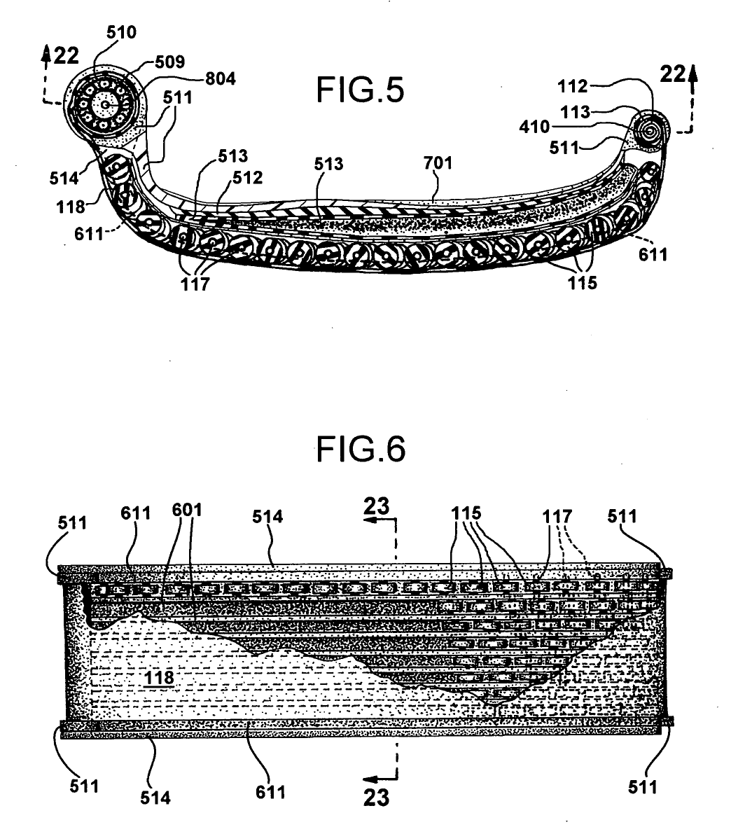

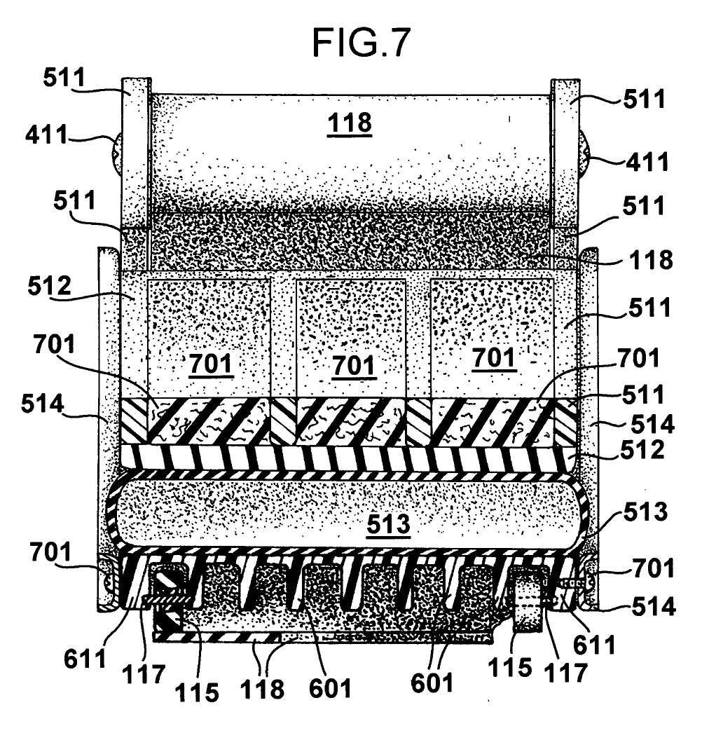

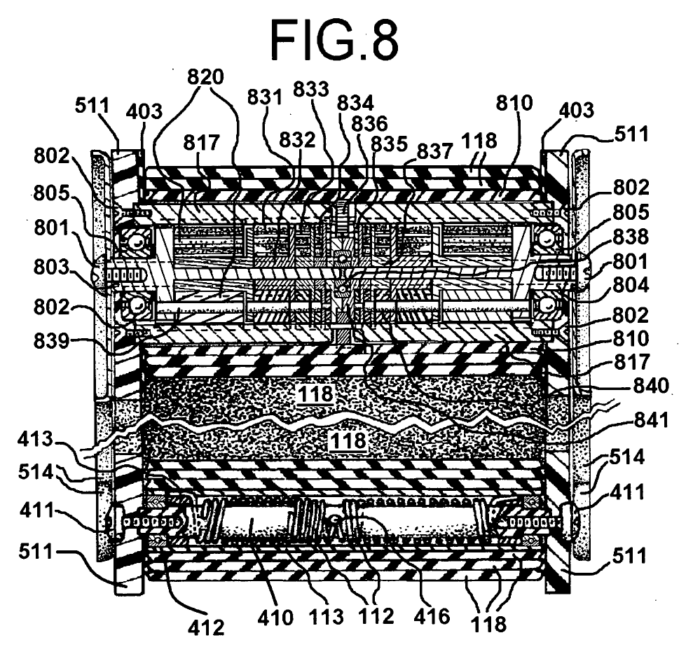

Another embodiment of the present invention is illustrated with the help of FIG. 5 through FIG. 7. Hinged cradle base 511 is a tough thermoplastic structure to hold spool 510 and second spool 113 (FIG. 5 and FIG. 8) with the rest of the components- Hinged base plate 611 has mostly equidistance parallel ridges 601 (FIG. 5, FIG. 6 and FIG. 7) to rotatably hold rollers 117 (FIG. 5, FIG. 6 and FIG. 7) by their spindles 115 (FIG. 5, FIG. 6 and FIG. 7). Sole filler 701 (FIG. 7) is of light elastomeric composition. Sole filler 701 provides a comfortable base to the appendage, in this case, the foot, engaged in bipedal (or quadruped, in other embodiments of the present invention) locomotion. Hinged cradle base 511 acts along with hinged base plate 611 as the upper and lower arms of a nutcracker-like lever device; and this lever device functions as the pedal-pressure-receiving mechanism, the function of which has been explained hereinbefore. Flexible low-pressure air bag 513 (FIG. 5 and FIG. 7) is used to protect the free space needed between hinged cradle base 511 and hinged base plate 611 for the proper functioning of this lever device. A compression of nearly 10 mm. or more of flexible low-pressure air bag 513 is required for adequate step conveyance. The essential functioning of the embodiments of the present invention is identical to the first-described embodiment hereinabove. Many elements which are essentially identical, bear the same indicia as used in the description of the first-described embodiment. These are helically wound springs 112 (FIG. 5 and FIG. 8), second spool 113 (FIG. 5 and FIG. 7), spindles 115 (FIG. 5, FIG. 6 and FIG. 7), rollers 117 (FIG. 5, FIG. 6 and FIG. 7), strip 118 (FIG. 5 through FIG. 8), thin rubber washers 403 (FIG. 8), end-plate-locating shaft 410 (FIG. 8), ball bearings 412 (FIG. 8), holder ring 413 (FIG. 8) and hole 416 (FIG. 8), used interchangeably with the first embodiment of the present invention. Additionally, the indicia used are either three or four digit; in a three-digit index number, the third digit from the left indicates the primary figure number it belongs to, similarly, in a four-digit index number, the two digits from the left indicate the figure number. Link arm 514 (FIG. 5 through FIG. 8) firmly links hinged base plate 611 to the hinge axis, first planet driver gear wheel 803 (FIG. 8) with the use of securing bolt 801 (FIG. 8). First planet driver gear wheel 803 is rotatably secured to hinged cradle base 511 by axle bearing 805 (FIG. 8). Fixed common annulus gear wheel 817 (FIG. 8) has lengthwise internal gear teeth and it spans the width of strip 118; it is secured to hinged cradle base 511 with the use of high-tensile fasteners 802 (FIG. 8). Various elements 831 to 841 constitute two symmetrical axially side-by-side-located 5-stage epicyclic gear trains with fixed common annulus gear wheel 817. Spool 810 (FIG. 8) is driven by small planet gear wheels with fixed common annulus gear wheel 817 functioning as the fixed planet carrier. The manner of driving is similar to the one described in the earlier embodiment of the present invention. The diametral pitch for the gear teeth on fixed common annulus gear wheel 817 is 20 or 21. It is also important to use high-strength alloy steel for the construction of annulus gear wheel 817, first planet driver gear wheel 803 and first set of planetary gears 820 rotatably fixed on corresponding planet carrier shafts 839. This is important for the reliability of the device, as the torque is considerably high at this stage. One small ball bearing 838 (FIG. 8) axially and medially links the two symmetrically placed first planet driver gear wheels 803. It is also important to make link arm 514 with high-strength alloy steel. The operation of the presently described embodiment of the present invention is exactly similar to the first-mentioned embodiment of the present invention. In order to build in a dc or BLDC motor to augment the torque on spool 810, the diameter of spool 810 has to be increased in order to reduce the length of the gear trains without compromising the gear strength. Then the dc or BLDC motor can be put at the place marked by small ball bearing 838 in FIG. 8. One familiar with similar technology can easily conceive and execute this slight redesign from the guidelines laid down here. The internal lubrication of all the gear trains is very important; for this purpose, use has to be made of double-z bearings for axle bearing 805 and the internal space of annulus gear wheel 817, which is actually a whole gear box, has to be filled up with a suitable gear lubricant which can be effective for a wide range of gear speeds. If the gear lubricant is fluidic, then the slight leakage of the lubricant will also hydro-dynamically lubricate the angular bearing formed between the angular internal surface of spool 810 and the angular external surface annulus gear wheel 817 (FIG. 8).

For an ergonomic construction of any embodiment of the present invention for human use, a number of strips 1018 (FIG. 10) somewhat in the form of V-belts are employed; rollers 115 are modified to form pulleys 1015 (FIG. 10) with spindles 1017, which guide strips 1018 through curved grooves 918 (FIG. 9). Curved grooves 918 follow the outer planar profile of device base 920 (FIG. 9). Device base 920 could form the ground-contacting base of any of the embodiments of the present invention. The outer planar profile of device base 920 also forms the outer mechanical structure 921 (FIG. 9) of any device of the present invention. Outer mechanical structure 921 can be cradle base 111 (FIG. 2) or hinged base plate 611 and link arm 514 (FIG. 6), like one shown as 1011 in FIG. 10—a small mechanical locking mechanism can be implemented in these elements for minimizing the movements of the devices of the present invention when intended, as discussed in the preceding section. Spool 810 (or spool 110) and second spool 113 are located in FIG. 9 at locations 910 (FIG. 9) and 913 (FIG. 9) respectively. To accommodate different lengths of strips 1018 spool 810 (or spool 110) and second spool 113 are constituted of stepped rings joined up axially making up stepped spool 1013 (FIG. 10). Stepped spool 1013 is generally profiled at locations 910 and 913 (FIG. 9). Grit and dust are not a major problem when a number of strips 1018 are used; but with the use of strip 118, grit can get between rollers 115 and foul the functioning of the devices of present invention. To prevent this from happening, rubber curtains or baffles are used lengthwise on both the sides of strip 118. The curtains or baffles rub slightly against strip 118, and are fixed lengthwise on the two sides of either cradle base 111 or base plate 611, depending upon the form of the present invention being made. Similarly, in the first-explained embodiment of the present invention, transverse rubber curtains also scrape against strip 118 from upper and lower horizontal sides just before strip 118 gets wound around spool 110 (FIG. 4) or spool 810 (FIG. 8), depending upon the embodiment being constructed. This light scraping action of transverse rubber curtains acts as a seal, as well as a mud remover in case of the use of the devices of present invention in muddy conditions. Strip 118 or strips 1018 can have smooth internal-facing surfaces made of a flexible and strong metal like stainless steel. This metal backing makes strip 118 or strips 1018 flexible but not prone to permanent elongation. This also minimizes chances of grit or dust sticking to or embedding into strip 118 or strips 1018. Strip 118 can also have small regular perforation or openings to let grit or dust find a way out to the ground and prevent a continuous accumulation around rollers 115.

All the above-discussed embodiments can be used in quadruped locomotion with just dimensional modifications. As the embodiments of the present invention are neither wheeled nor endless-track vehicles, quadruped animals of burden or domesticated pack animals need not learn much in order to adapt to the devices of the present invention. Horseshoes, anyway, are essential for enabling hoofed animals to tread on cast or cobbled road surfaces; these devices simply dynamic and functional replacements for horseshoes.

Presently, the electrical-energy storage devices are volumetrically not very efficient. But superconductors and future rechargeable batteries are promising. Instead of having hydraulic rotary actuators or epicyclic gear boxes to drive the devices of present invention, only electric motors can be used to wind strip 118 or strips 1018, drawing power from an efficient electric source small enough to get into the device of present invention. Somebody versed in related art can easily understand and implement such an embodiment of the present invention even with the present-day batteries. In such a case the pedal-pressure-receiving mechanism has a built-in pedal-pressure transducer in the form of a switch or a pressure transducer to activate an electronic circuitry to drive a small dc or BLDC motor to accomplish the winding of strip 110 or strips 1018 around spool 110 or 810, depending upon the embodiment of the present invention intended to be used. However, electronic data processing circuitry can be incorporated in the devices of the present invention to sense insufficiency of torque to achieve translatory motion in the cases of climbing a gradient. Electrical torque augmentation can provide locomotion assistance in such a case. Data curves of torque or pressure generated versus translatory motion achieved will differentiate a climb from a descent quite clearly. In a climbing locomotion all the values for torque or pressure and the translatory motion achieved will drop; however, during a descending locomotion the values for torque or pressure will drop but translatory motion achieved will remain constant. One versed in related art shall fully understand and execute the features laid out in the following claims with the help of the preceding description.

What is claimed is:

1. A sole-forming pedal device comprising:
a pedal-pressure-receiving mechanism,
a pedal-pressure-transforming mechanism to transform the force of said pedal pressure imparted upon said pedal-pressure-receiving mechanism into a couple of force to apply a torque on a spindle for winding of a strip or a plurality of side-by-side strips around a spool;
said strip or said plurality of side-by-side strips engagingly pressed to the ground by a plurality of rollers or pulleys distributed in a definite pattern and all said rollers or pulleys rotatably attached to a plane;
said plane either firmly, resiliently or pivotally connected to said pedal-pressure-receiving mechanism to function as the groundside bottom half of said pedal-pressure-receiving mechanism;
said winding of said strip or said plurality of side-by-side strips around said spool effecting the inducement of rectilinear motion in the fore-and-aft axis of said sole-forming pedal device by said strip or said plurality of side-by-side strips frictionally adhering to the ground, on the ground-facing side during said winding;
a coiled up potential energy storage device coils up with said winding of said strip or said plurality of side-by-side strips around said spool and successively intermittent removal or reversal of said pedal pressure during the act of bipedal or quadruped locomotion induces said coiled up potential energy storage device to uncoil and apply a torque on a second spool rotatably fixed to said pedal-pressure-receiving mechanism, for the unwinding of said winding of said strip or said plurality of side-by-side strips around said spool and to spirally bear and stressfully hold the unwound said winding of said strip or said plurality of side-by-side strips around said spool;
said spool located on or near the rear end of said fore-and-aft axis of said sole-forming pedal device and said second spool located on or near the front end of said fore-and-aft axis of said sole-forming pedal device; and
an energized pedal appendage linked to said pedal-pressure-receiving mechanism, engaged in a bipedal or quadruped locomotion.

2. A sole-forming pedal device in accordance with claim 1, wherein said strip or said plurality of side-by-side strips either have reinforcements in the form of cords made of high-tensile material or have inside surface or surfaces lined with thin metal sheet or sheets, which remains/remain in contact with said plurality of rollers or pulleys.

3. A sole-forming pedal device in accordance with claim 1, wherein said strip has evenly distributed perforations or openings to allow foreign matter to settle to the ground surface.

4. A sole-forming pedal device in accordance with claim 1, wherein said plurality of side-by-side strips engagingly pressed to the ground by said plurality of rollers or pulleys distributed in said pattern and all said rollers or pulleys rotatably attached to said plane; said pattern has widthwise equidistance grooves in sympathy with the outer profile of said plane, fully spanning said fore-and-aft axis with said rollers or pulleys rotatably attached to said plane and entrenched radially in said grooves with the axes of said rollers or pulleys horizontally intersecting said fore-and-aft axis normally; said spool and said second spool have respective axial lengths identically divided in annuluses of a plurality equaling said plurality of side-by-side strips and said annuluses which are of different external diameters, together bring about the resemblance of a hyperboloid of one sheet to the external surfaces of said spool and said second spool, except for the axial steps formed by said annuluses which are of different external diameters.

5. A sole-forming pedal device in accordance with claim 1, wherein said pedal-pressure-transforming mechanism is hydrostatic and comprises:
said pedal-pressure-receiving mechanism made as a sole bearing, resilient, sealed, flat-pack cavity with or without ridges and with at least one tubular outlet, fully filled up with a hydraulic fluid;
said tubular outlet opening through a manually operated throttle valve to allow hydraulic fluid, pressurized by said force of said force of said pedal pressure, into a hydraulic, single-rod, single-acting, spring-return cylinder with a mechanism to prevent the piston rod of said hydraulic cylinder from rotating and said piston rod having at least one helical groove of any profile on the cylindrical external surface of said rod to form a helical screw or ball-screw rotary actuator, the rotary drive shaft of said helical screw or ball-screw rotary actuator having angularly placed gear teeth to form a driver sun gear wheel to drive and rotate an encircling, internally geared annulus gearwheel follower by rotating a plurality of planet gear wheels rotatably fixed in radial equidistance in axial slots formed in the non-hydraulic section of the piston-rod end of the housing of said hydraulic, single-acting, spring-return cylinder,
said encircling, internally geared annulus gear wheel follower is flanked by at least one cylindrical sleeve and is encircled by and fixed to said spool which is hollow and cylindrical and which rotates in conjunction with said encircling, internally geared annulus gear wheel follower,
said spool which rotates in conjunction with said encircling, internally geared annulus gear wheel follower, in turn winds said strip or said plurality of side-by-side strips around said spool;
said unwinding of said winding of said strip or said plurality of side-by-side strips around said spool effects the spring-return action of the piston of said hydraulic cylinder.

6. A sole-forming pedal device in accordance with claim 5, wherein said hydraulic, single-rod, single-acting, spring-return cylinder with said mechanism to prevent the piston rod of said hydraulic cylinder from rotating and said piston rod having at least one helical groove of any profile on said cylindrical external surface of said rod to form said helical screw or ball-screw rotary actuator, the rotary drive shaft of said helical screw or ball-screw rotary actuator having gear teeth to form said driver sun gear wheel is replaced with either a vane- or gear-type hydraulic motor with a shaft having gear teeth to form a driver sun gear wheel to drive and rotate said encircling, internally geared annulus gear wheel follower by rotating said plurality of planet gear wheels rotatably fixed in radial equidistance in axial slots formed in a hollow cylinder functioning as the axle to said spool and also functioning as a housing to said hydraulic motor, and said hydraulic motor having a hydraulic connection to a hydraulic tank through a check valve;
said sole bearing, resilient, sealed, flat-pack cavity with or without ridges and with at least one tubular outlet, fully filled up with a hydraulic fluid, has an added spring-return structure or member and an added hydraulic line connected to said hydraulic tank through a check valve.

7. A sole-forming pedal devices in accordance with claim 5, wherein said strip non-engagingly and lightly pressed towards the ground by at least two, at least one near each widthwise end, polymeric or elastomeric stressed curtains or baffles attached to said plane, protecting the engaging surface of said strip engagingly pressed to the ground by said plurality of rollers distributed in a definite pattern and the engaging angular surfaces of said plurality of rollers.

8. A sole-forming pedal device in accordance with claim 1, wherein said pedal-pressure-transforming mechanism is gear-train activated and comprises:
said pedal-pressure-receiving mechanism made as a sole-bearing structure of nutcracker-like construction with two arms and the hinge linking said two arms integrated with a compound epicyclic gear-train box which is fully encircled by said spool and which also drives and rotates said spool, receiving said force of said pedal pressure by driving and rotating an internally geared annulus gear wheel follower, encircled by and joined to said spool, rotationally driven by a plurality of planet gear wheels rotatably fixed in radial equidistance in axial slots formed in the hollow cylindrical housing of said compound epicyclic gear-train box;
said hollow cylindrical housing of said compound epicyclic gear-train box having radially interspaced gear teeth to function as the fixed, annulus gear wheel common to all of the planet gear wheels rotatably fixed on respective planet carriers and logically interlinked through respective sun wheels to each other to achieve a torque reduction and corresponding angular-velocity increase in said spool;
said spool which rotates in conjunction with said encircling, internally geared annulus gear wheel follower, in turn winds said strip or said plurality of side-by-side strips around said spool;
said unwinding of said winding of said strip or said plurality of side-by-side strips around said spool effecting the increase in the angular distance between said two arms of said pedal-pressure-receiving mechanism made as said sole-bearing structure of nutcracker-like construction; and
a manually or foot-operated latching mechanism near the front end of the fore-and-aft axis of said sole-forming pedal device to lock said two arms of said pedal-pressure-receiving mechanism to hold to a minimum of said angular distance between said two arms of said pedal-pressure-receiving mechanism.

9. A pair of identical or mirror-image sole-forming pedal devices for a pair of shoes, each of said pair of mirror-image sole-forming pedal devices comprising:
a pedal-pressure-receiving mechanism;
a pedal-pressure-transforming mechanism to transform, with or without augmentation, the force of said pedal pressure imparted upon said pedal-pressure-receiving mechanism into a couple of force to apply a torque on a spindle for winding of a strip or a plurality of side-by-side strips around a spool;
said strip or said plurality of side-by-side strips engagingly pressed to the ground by a plurality of rollers or pulleys distributed in a definite pattern and all said rollers or pulleys rotatably attached to a plane;
said plane either firmly, resiliently or pivotally connected to said pedal-pressure-receiving mechanism to function as the groundside bottom half of said pedal-pressure-receiving mechanism;
said winding of said strip or said plurality of side-by-side strips around said spool effecting the inducement of rectilinear motion in the fore-and-aft axis of said sole-forming pedal device by said strip or said plurality of side-by-side strips frictionally adhering to the ground, on the ground-facing side during said winding;
a coiled up potential energy storage device coils up with said winding of said strip or said plurality of side-by-side strips around said spool and successively intermittent removal or reversal of said pedal pressure during the act of bipedal or quadruped locomotion induces said coiled up potential energy storage device to uncoil and apply a torque on a second spool rotatably fixed to said pedal-pressure-receiving mechanism, to unwind said winding of said strip or said plurality of side-by-side strips around said spool and to spirally bear and stressfully hold the unwound said winding of said strip or said plurality of side-by-side strips around said spool; and
said spool located on or near the rear end of said fore-and-aft axis of said sole-forming pedal device and said second spool located on or near the front end of said fore-and-aft axis of said sole-forming pedal device protected on the dorsal side with flexible coverings.

10. Each of said pair of mirror-image sole-forming pedal devices in accordance with claim 9, wherein said pedal-pressure-transforming mechanism to transform, with or without augmentation, said force of said pedal pressure imparted upon said pedal-pressure-receiving mechanism into said couple of force to apply said torque on said spindle for winding of said strip or said plurality of side-by-side strips around said spool has a small dc or brush-less dc motor driven by an inbuilt or portable electric power source in the form of a rechargeable battery or a superconductor assembly linked to said spindle for said augmentation; and said small dc or brush-less dc motor also functioning as an electric generator to charge via an electronic switching and regulatory circuitry said rechargeable battery or said superconductor assembly at the time of absence of said augmentation.

11. Each of said pair of mirror-image sole-forming pedal devices in accordance with claim 9, wherein said pedal-pressure-transforming mechanism is hydrostatic and comprises:
said pedal-pressure-receiving mechanism made as a sole bearing, resilient, sealed, flat-pack cavity with or without ridges and with at least one tubular outlet, fully filled up with a hydraulic fluid;
said tubular outlet opening through a manually or pilot-operated throttle valve to allow hydraulic fluid, pressurized by said force of said force of said pedal pressure, into a hydraulic, single-rod, single-acting, spring-return cylinder with a mechanism to prevent the piston rod of said hydraulic cylinder from rotating and said piston rod having at least one helical groove of any profile on the cylindrical external surface of said rod to form a helical screw or ball-screw rotary actuator, the rotary drive shaft of said helical screw or ball-screw rotary actuator having angularly placed gear teeth to form a driver sun gear wheel to drive and rotate an encircling, internally geared annulus gear wheel follower by rotating a plurality of planet gear wheels rotatably fixed in radial equidistance in axial slots formed in the non-hydraulic section of the piston-rod end of the housing of said hydraulic, single-acting, spring-return cylinder,
said encircling, internally geared annulus gear wheel follower is flanked by at least one cylindrical sleeve and is encircled by and fixed to said spool which is hollow and cylindrical and which rotates in conjunction with said encircling, internally geared annulus gear wheel follower,
said spool which rotates in conjunction with said encircling, internally geared annulus gear wheel follower, in turn winds said strip or said plurality of side-by-side strips around said spool;
said unwinding of said winding of said strip or said plurality of side-by-side strips around said spool effects the spring-return action of the piston of said hydraulic cylinder.

12. A sole-forming pedal device in accordance with claim 11, wherein said hydraulic, single-rod, single-acting, spring-return cylinder with said mechanism to prevent the piston rod of said hydraulic cylinder from rotating and said piston rod having at least one helical groove of any profile on said cylindrical external surface of said rod to form said helical screw or ball-screw rotary actuator, said rotary drive shaft of said helical screw or ball-screw rotary actuator having gear teeth to form said driver sun gear wheel is replaced with either a vane- or gear-type hydraulic motor with a shaft having gear teeth to form a driver sun gear wheel to drive and rotate said encircling, internally geared annulus gear wheel follower by rotating said plurality of planet gear wheels rotatably fixed in radial equidistance in axial slots formed in a hollow cylinder functioning as the axle to said spool and also functioning as a housing to said hydraulic motor, and said hydraulic motor having a hydraulic connection to a hydraulic tank through a check valve;
said sole bearing, resilient, sealed, flat-pack cavity with or without ridges and with at least one tubular outlet, fully filled up with a hydraulic fluid, has an added spring-return structure or member and an added hydraulic line connected to said hydraulic tank through a check valve.

13. Each of said pair of mirror-image sole-forming pedal devices in accordance with claim 11, wherein said strip non-engagingly lightly pressed towards the ground by at least two, at least one near each widthwise end, polymeric or elastomeric stressed curtains or baffles attached to said plane, protecting the engaging surface of said strip engagingly pressed to the ground by said plurality of rollers distributed in a definite pattern and the engaging angular surfaces of said plurality of rollers.

14. Each of said two mirror-image sole-forming pedal devices in accordance with claim 9, wherein said pedal-pressure-transforming mechanism is gear train activated and comprises: said pedal-pressure-receiving mechanism made as a sole-bearing structure of nutcracker-like construction with two arms and the hinge linking said two arms integrated with a compound epicyclic gear-train box which is fully encircled by said spool and which also drives and rotates said spool, receiving said force of said pedal pressure by driving and rotating an internally geared annulus gear wheel follower, encircled by and joined to said spool, rotatably driven by a plurality of planet gear wheels rotatably fixed in radial equidistance in axial slots formed in hollow cylindrical housing of said compound epicyclic gear-train box;
said hollow cylindrical housing of said compound epicyclic gear box having radially interspaced gear teeth to function as the fixed, annulus gear wheel common to all of the planet gear wheels rotatably fixed on respective planet carriers and logically interlinked to respective sun gear wheels to achieve a torque reduction and corresponding angular-velocity increase in said spool;
said spool which rotates in conjunction with said encircling, internally geared annulus gear wheel follower, in turn winds said strip or said plurality of side-by-side strips around said spool;
said unwinding of said winding of said strip or said plurality of side-by-side strips around said spool effects the increase in the angular distance between said two arms of said pedal-pressure-receiving mechanism made as said sole-bearing structure of nutcracker-like construction; and
a manually or foot-operated latching mechanism near the front end of the fore-and-aft axis of said sole-forming pedal device to lock said two arms of said pedal-pressure-receiving mechanism to hold to a minimum of said angular distance between said two arms of said pedal-pressure-receiving mechanism.

15. Each of said two mirror-image sole-forming pedal devices in accordance with claim 9, wherein a strip or a plurality of side-by-side strips either have reinforcements in the form of cords made of high-tensile material or have inside surface or surfaces lined with thin metal sheet or sheets, which remain in contact with said plurality of rollers or pulleys.

16. Each of said two mirror-image sole-forming pedal devices in accordance with claim 9, wherein said strip has evenly distributed perforations or openings to allow foreign matter to settle to the ground surface.

17. Each of said two mirror-image sole-forming pedal devices in accordance with claim 9, wherein said plurality of side-by-side strips engagingly pressed to the ground by said plurality of rollers or pulleys distributed in said pattern and all said rollers or pulleys rotatably attached to said plane; said pattern has widthwise equidistance grooves in sympathy with the outer profile of said plane, fully spanning said fore-and-aft axis with said rollers or pulleys rotatably attached to said plane and entrenched radially in said grooves with the axes of said rollers or pulleys horizontally intersecting said fore-and-aft axis normally; said spool and said second spool have respective axial lengths identically divided in annuluses of a plurality equaling said plurality of side-by-side strips and said annuluses which are of different external diameters, together bring about the resemblance of a hyperboloid of one sheet to the external surfaces of said spool and said second spool, except for the axial steps formed by said annuluses which are of different external diameters.

18. A sole-forming pedal device comprising:
a pedal-pressure-receiving mechanism;
a pedal-pressure transducer mechanism for sensing the force of said pedal pressure imparted upon said pedal-pressure-receiving mechanism for the electromagnetic generation of a couple of force to apply a torque on a spindle for winding of a strip or a plurality of side-by-side strips around a spool;
said electromagnetic generation by an electric motor coupled to a torque transformation mechanism in the form of a gear train, and supplied with electric power from an electric power source in the form of a battery or a superconductor assembly proximal to or integrated with said sole-forming pedal device;
said strip or said plurality of side-by-side strips engagingly pressed to the ground by a plurality of rollers or pulleys distributed in a definite pattern and all said rollers or pulleys rotatably attached to a plane;
said plane either firmly, resiliently or pivotally connected to said pedal-pressure-receiving mechanism to function as the groundside bottom half of said pedal-pressure-receiving mechanism;
said winding of said strip or said plurality of side-by-side strips around said spool effecting the inducement of rectilinear motion in the fore-and-aft axis of said sole-forming pedal device by said strip or said plurality of side-by-side strips frictionally adhering to the ground, on the ground-facing side during said winding;
a coiled up potential energy storage device coils up with said winding of said strip or said plurality of side-by-side strips around said spool and successively intermittent removal or reversal of said pedal pressure during the act of bipedal or quadruped locomotion induces said coiled up potential energy storage device to uncoil and apply a torque on a second spool rotatably fixed to said pedal-pressure-receiving mechanism, to unwind said winding of said strip or said plurality of side-by-side strips around said spool and to spirally bear and stressfully hold the unwound said winding of said strip or said plurality of side-by-side strips around said spool;
said spool located on or near the rear end of said fore-and-aft axis of said sole-forming pedal device and said second spool located on or near the front end of said fore-and-aft axis of said sole-forming pedal device; and
an energized pedal appendage linked to said pedal-pressure-receiving mechanism, engaged in a bipedal or quadruped locomotion.

19. A vehicular arrangement comprising a plurality of biologically energized and coordinated legs forming pedal appendages, each said pedal appendage equipped on the distal, ground-contacting end with a sole-forming pedal device and each such said sole-forming pedal device comprising:
a pedal-pressure-receiving mechanism;
a pedal-pressure-transforming mechanism to transform, with or without augmentation, the force of said pedal pressure imparted upon said pedal pressure receiving mechanism into a couple of force to apply a torque on a spindle for winding of a strip or a plurality of side-by-side strips around a spool;
said strip or said plurality of side-by-side strips engagingly pressed to the ground by a plurality of rollers or pulleys distributed in a definite pattern and all said rollers or pulleys rotatably attached to a plane;
said plane either firmly, resiliently or pivotally connected to said pedal-pressure-receiving mechanism to function as the groundside bottom half of said pedal-pressure-receiving mechanism;
said winding of said strip or said plurality of side-by-side strips around said spool effecting the inducement of rectilinear motion in the fore-and-aft axis of said sole-forming pedal device by said strip or said plurality of side-by-side strips frictionally adhering to the ground, on the ground-facing side during said winding;
a coiled up potential energy storage device coils up with said winding of said strip or said plurality of side-by-side strips around said spool and successively intermittent removal or reversal of said pedal pressure during the act of bipedal or quadruped locomotion induces said coiled up potential energy storage device to uncoil and apply a torque on a second spool rotatably fixed to said pedal-pressure-receiving mechanism, to unwind said winding of said strip or said plurality of side-by-side strips around said spool and to spirally bear and stressfully hold the unwound said winding of said strip or said plurality of side-by-side strips around said spool; and
said spool located on or near the rear end of said fore-and-aft axis of said sole-forming pedal device and said second spool located on or near the front end of said fore-and-aft axis of said sole-forming pedal device.

20. Each such said sole-forming pedal devices in accordance with claim 19, wherein said pedal-pressure-transforming mechanism to transform, with or without augmentation, the force of said pedal pressure imparted upon said pedal-pressure-receiving mechanism into said couple of force to apply said torque on said spindle for winding of said strip or said plurality of side-by-side strips around said spool has a small dc or brush-less dc motor driven by an inbuilt or portable electric power source in the form of a rechargeable battery or a superconductor assembly linked to said spindle for said augmentation; and said small dc or brush-less dc motor also functioning as an electric generator to charge via an electronic switching and regulatory circuitry said rechargeable battery or said superconductor assembly in the absence of said augmentation.
